(19) United States
(12) Patent Application Publication
(10) Pub. No.: US 2025/0270378 A1
(43) Pub. Date: Aug. 28, 2025

(54) STABILIZERS FOR POLYURETHANE FOAMS CONTAINING RECYCLED POLYOL

(71) Applicant: Evonik Operations GmbH, Essen (DE)

(72) Inventors: Michael Suchan, Gelsenkirchen (DE); Sarah Otto, Essen (DE); Michael Ferenz, Essen (DE)

(73) Assignee: Evonik Operations GmbH, Essen (DE)

(21) Appl. No.: 19/055,679

(22) Filed: Feb. 18, 2025

(30) Foreign Application Priority Data
Feb. 22, 2024 (EP) 24159158.5

(51) Int. Cl. C08J 9/00; C08J 9/14

(52) U.S. Cl. CPC C08J 9/0061; C08J 9/141; C08J 9/142; C08J 9/144; C08J 2375/04; C08J 2433/08; C08J 2433/10

(57) ABSTRACT

A composition for the production of polyurethane foam has a polyol component having at least one recycled polyol, a polyisocyanate component, at least one catalyst, and at least one blowing agent. The polyol component has at least one recycled polyol. The composition additionally has at least one acrylate and/or methacrylate copolymer as foam stabilizer. The at least one acrylate and/or methacrylate copolymer is present in a total amount of 0.1 to 20 parts by weight, preferably 0.5 to 10 parts by weight, particularly preferably 0.5 to 8 parts by weight, based on 100 parts by weight of the total polyol component.

### CROSS-REFERENCE TO RELATED APPLICATIONS

This patent application claims priority to European Patent Application No. 24159158.5, filed on Feb. 22, 2024, in the European Patent Office, the entire disclosure of which is hereby incorporated by reference herein.

### BACKGROUND OF THE INVENTION

### Field of the Invention

The present invention is in the field of polyurethanes. In particular, it relates to a composition for the production of polyurethane foam, to a process for producing polyurethane foam, and also to the polyurethane foam produced by the process and the use thereof.

The terms “polyurethane” and “polyurethane foam” are established technical terms which have long been known to those skilled in the art. Polyurethane (PU) in the context of the present invention is especially understood to mean a product obtainable by reaction of a polyisocyanate component with a polyol component. In addition to the polyurethane, further functional groups may also be formed in the reaction, for example uretdiones, carbodiimides, isocyanurates, allophanates, biurets, ureas and/or uretonimines. For the purposes of the present invention, therefore, polyurethane (PU) is understood as meaning not just polyurethanes, but also polyisocyanurates, polyureas and also polyisocyanate reaction products containing uretdione, carbodiimide, allophanate, biuret and/or uretonimine groups. The term polyurethane should accordingly be understood as a generic term for any polymer prepared from polyisocyanates and polyols or other isocyanate-reactive species, for example amines, though the urethane bond need not be the only or predominant type of bond. Polyisocyanurates and polyureas are expressly included in particular. Accordingly, polyurethane foam (PU foam) in the context of the present invention is understood to mean a foam which is obtained as a reaction product of a polyisocyanate component and a polyol component. In addition to the eponymous polyurethane, further functional groups may be formed here as well, examples being allophanates, biurets, ureas, carbodiimides, uretdiones, isocyanurates or uretonimines.

### Description of Related Art

Foams and PU foams are known per se. Rigid PU foam is an established technical term. The known and fundamental difference between flexible foam and rigid foam is that flexible foam shows elastic characteristics and hence deformation is reversible. By contrast, rigid foam is permanently deformed. Further details regarding rigid polyurethane foams can also be found for example in “Kunststoffhandbuch, Band 7, Polyurethane [Plastics Handbook, volume 7, Polyurethanes]”, Carl Hanser Verlag, 3rd Edition 1993, Chapter 6.

Polyurethane foams, especially corresponding rigid foams, can usually be produced using cell-stabilizing or foam-stabilizing additives (so-called foam stabilizers) to ensure a fine-celled, uniform and low-defect foam structure and hence to exert an essentially positive influence on the use properties, for example the thermal insulation performance, of the rigid foam. Surfactants based on polyether-modified siloxanes are particularly effective and therefore represent the preferred type of foam stabilizers. These so-called polyethersiloxane foam stabilizers (PESs) are sufficiently well known from the prior art and are described extensively, for example, in CN 103665385 A, CN 103657518 A, CN 103055759 A, CN 103044687 A, US 2008/0125503 A1, US 2015/0057384 A1, EP 1520870 A1, EP 1211279 A1, EP 0867464 A1, EP 0867465 A1 and in EP 0275563 A1.

EP 3957669 A1 describes foam stabilizers based on methacrylates in conventional rigid polyurethane foam formulations without recycled polyols which lead to comparable properties to the foams produced with polyether-modified siloxanes.

A particularly important concern associated with the provision of PU foams, especially rigid PU foams, is that of producing them from particularly sustainable materials and contributing to a functioning circular economy in the sector of polyurethane foams. This can be accomplished, for example, by the use of recycled polyols, which are preferably obtained by chemical recycling, i.e. depolymerization of polyurethane, in particular polyurethane foam and particularly preferably rigid polyurethane foam. Possibilities for preparing such recycled polyols are known and are described extensively, inter alia, for example in WO 2018/091575 A1, CN 114106281 A, U.S. Pat. No. 3,441,616, EP 0105167 A1, DD 226575 A1, U.S. Pat. No. 5,274,004, DE 4217024 A1, DE 4234335 A1, DE 4442379 A1, EP 718349 A1, DE 19510638 A1, DE 19622761 A1, U.S. Pat. No. 5,763,692, WO 2022063764 A1, WO 2015027319 A1, CN 105399985 A, WO 2020080619 A1, WO 2019219814 A1, WO 2021023889 A1 and in WO 2022135987 A1. Processes such as for example glycolysis, alcoholysis, acidolysis, aminolysis, hydrolysis, or solvolysis, inter alia, can be employed.

Recycled polyols can preferably be prepared from production waste that is obtained during polyurethane foam production, such as for example cutting scraps, sawing waste or material that does not pass quality control, but also, for example, from polyurethane foam waste, so-called waste foams, which have reached the end of their service life, such as for example foams from used refrigeration appliances, used insulating materials or insulating panels, used sealing foams, used mattresses, used furniture, used sound absorption materials, used packaging foams, or used vehicles.

However, the use of high proportions of such recycled polyols has to date often led to a deterioration in the foam quality and there is therefore usually a significant limit on the amount of recycled polyols used in the polyurethane foam, especially in the case of the customary use of the polyether-modified siloxanes typically used to date.

There therefore remains a need for the provision of PU foam, preferably rigid PU foam, where the use even of relatively high proportions of recycled polyols should be made possible and where comparable or even better foam qualities result, in particular with respect to a low thermal conductivity and/or good surface quality, compared to the use of conventional polyethersiloxanes.

### SUMMARY OF THE INVENTION

The provision of corresponding polyurethane foams is therefore the object of the invention.

It was surprisingly found in the context of the present invention that this can be made possible by the use according to the invention of at least one acrylate and/or methacrylate copolymer as foam stabilizer, preferably as specified in the embodiments.

The object is achieved by the subject matter of the invention. The invention provides a composition for the production of polyurethane foam, preferably rigid polyurethane foam, comprising
a polyol component comprising at least one recycled polyol,
a polyisocyanate component,
at least one catalyst that catalyses the isocyanate-polyol and/or isocyanate-water reactions and/or isocyanate trimerization,
at least one blowing agent,
   wherein the composition additionally contains at least one acrylate and/or methacrylate copolymer as foam stabilizer, wherein the at least one acrylate and/or methacrylate copolymer is present in a total amount of 0.1 to 20 parts by weight, preferably 0.5 to 10 parts by weight, particularly preferably 0.5 to 8 parts by weight, based on 100 parts by weight of the total polyol component.

### DETAILED DESCRIPTION OF THE INVENTION

The subject matter of the invention is associated with a variety of advantages. The subject matter of the invention enables the provision of PU foam, preferably rigid PU foam, even using relatively high proportions of recycled polyols, where comparable foam qualities result, in particular with respect to a low thermal conductivity and/or good surface quality, compared to the use of conventional polyethersiloxanes. It enables the provision of PU foams that meet the known requirements and contain relatively high proportions of recycled polyols. The PU foams are advantageously dimensionally stable, have very good insulation properties and have a high surface quality. This is advantageously made possible without impairing the other properties of the material. Moreover, particularly fine-cell, homogeneous foam structures with a low level of defects are enabled.

The composition according to the invention contains at least one blowing agent. It is preferable that the at least one blowing agent is selected from the group consisting of
hydrocarbons having 3, 4 or 5 carbon atoms, preferably cyclo-, iso- and/or n-pentane,
hydrofluoroolefins and/or hydrohaloolefins, preferably 1234ze, 1234yf, 1224yd, 1233zd(E) and/or 1336mzz,
and
oxygen-containing blowing agents, preferably methyl formate, acetone and/or dimethoxymethane.

The composition according to the invention contains at least one acrylate and/or methacrylate copolymer. It is preferable that the at least one acrylate and/or methacrylate copolymer contains at least one comonomer of the H₂C═CR¹—COOR² type and at least one comonomer of the H₂C═CR¹—COOR³ type, where
R¹=each independently H or methyl, where different comonomers having different R¹ substituents may be present within one molecule,
R²=each independently a radical from the group of aliphatic or aromatic hydrocarbons having 1 to 25 carbon atoms, preferably methyl, ethyl, n-butyl, isobutyl, t-butyl, 2-ethylhexyl, isodecyl, cyclohexyl, benzyl, phenyl, isobornyl or allyl, where different comonomers having different R² substituents may be present within one molecule,
R³=each independently a polyether radical according to Formula 1, where different comonomers having different R³ substituents may be present within one molecule,

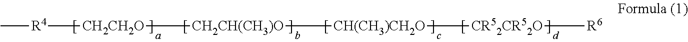

where
R⁴=each independently —CH₂—O—, —CH₂—CH₂—O—, —CH₂—CH₂—CH₂—O—, —CH₂—CH₂—CH₂—CH₂—O— or —CH₂—CH₂—CH₂—CH₂—CH₂—O—, where R⁴ may also be absent,
R⁵=each independently identical or different alkyl radicals which have 1 to 18 carbon atoms and optionally have ether functions, or identical or different aryl radicals which have 6 to 18 carbon atoms and optionally have ether functions, or H, preferably H, methyl, ethyl or benzyl,
R⁶=each independently identical or different radicals selected from the group consisting of R⁷, —C(O)R⁷, —CH₂—CH(OH)—CH₂OH and —CH₂—C(CH₂OH)₂—CH₂—CH₃, where H, methyl, ethyl, propyl, butyl and/or C(O)Me are particularly preferred,
R⁷=each independently identical or different aliphatic hydrocarbons having 1 to 25 carbon atoms, identical or different aryl radicals having 6 to 16 carbon atoms or H,
a=0 to 300, preferably 0 to 100, particularly preferably 0 to 80,
b=0 to 300, preferably 0 to 100, particularly preferably 0 to 80,
c=0 to 300, preferably 0 to 100, particularly preferably 0 to 80,
d=0 to 300, preferably 0 to 100, particularly preferably 0,
where a+b+c+d=2 to 500, preferably >5 to 300, particularly preferably 8 to 100.

It is preferable that the at least one acrylate and/or methacrylate copolymer has a weight-average molecular weight MW, determined by gel permeation chromatography in accordance with DIN 55672-1:2016-03 (eluent: tetrahydrofuran (THF); standard: polystyrene (PS)), in the range from 500 to 100 000 g/mol, particularly preferably 1000 to 20 000 g/mol, very particularly preferably 1000 to 15 000 g/mol.

The composition according to the invention contains at least one recycled polyol. It is preferable that the at least one recycled polyol is used in a total amount of at least 10 parts by weight, preferably more than 20 parts by weight, particularly preferably more than 30 parts by weight, based on 100 parts by weight of the total polyol component.

The at least one recycled polyol is preferably selected from the group consisting of recycled polyether polyol and recycled polyester polyol. Polyether polyols and polyester polyols are well known to the person skilled in the art and the known reaction thereof with polyisocyanates enables the tried and tested production of polyurethanes.

The at least one recycled polyol may preferably be one which has been obtained by depolymerization of polyurethane, preferably depolymerization of polyurethane by hydrolysis, solvolysis, aminolysis, acidolysis, alcoholysis or glycolysis, particularly preferably glycolysis, hydrolysis, or aminolysis, very particularly preferably glycolysis, with it also preferably being possible to use various recycled polyols from differing depolymerization processes.

It is preferable that the at least one recycled polyol has been obtained by depolymerization of polyurethane foam, preferably rigid polyurethane foam, particularly preferably polyurethane foam containing polyether polyol and/or polyester polyol, further preferably rigid polyurethane foam containing polyether polyol and/or polyester polyol, preferably according to a process specified in the embodiments, particularly preferably glycolysis.

In particular, it is preferable when the recycled polyol used has been obtained from a PU waste foam.

A PU waste foam is a PU foam which preferably
(i) results from production waste obtained during polyurethane foam production, such as for example cutting scraps, sawing waste or material that does not pass quality control, and/or
(ii) results from PU foams that have reached the end of their service life, such as for example foams from used refrigeration appliances, used insulating materials or insulating panels, used sealing foams, used mattresses, used furniture, used sound absorption materials, used packaging foams, or foams from used vehicles.

Acrylate and/or methacrylate copolymers and the production thereof are already known from the prior art and are for example described in EP 1070730 A2 or US 2014/0045993 A1. The foam stabilizers usable according to the invention, preferably as characterized in one of the embodiments, can be obtained in the usual ways known to the person skilled in the art, for example by free-radical polymerization of acrylates and/or methacrylates. This is demonstrated in the experimental section by way of example using a number of examples.

Acrylate and/or methacrylate monomers usable for the purposes of the invention are for example also commercially available, for example under the brand name VISIOMER® from Evonik Operations GmbH.

Examples of these are preferably, but are not limited to, methyl (meth)acrylate, ethyl (meth)acrylate, propyl (meth)acrylate, isopropyl (meth)acrylate, butyl (meth)acrylate, isobutyl (meth)acrylate, hexyl (meth)acrylate, ethylhexyl (meth)acrylate, isodecyl (meth)acrylate, cyclohexyl (meth)acrylate, tetrahydrofurfuryl (meth)acrylate, isobornyl (meth)acrylate, benzyl (meth)acrylate, phenyl (meth)acrylate, phenylethyl (meth)acrylate, 3,3,5-trimethylcyclohexyl (meth)acrylate, hydroxyalkyl (meth)acrylates, for example 3-hydroxypropyl methacrylate, 3,4-dihydroxybutyl methacrylate, 2-hydroxyethyl methacrylate, 2-hydroxypropyl methacrylate, 2,5-dimethylhexane-1,6-diol (meth)acrylate, decane-1,10-diol (meth)acrylate, glycol dimethacrylates, for example butane-1,4-diol methacrylate, 2-butoxyethyl methacrylate, 2-ethoxyethoxymethyl methacrylate, 2-ethoxyethyl methacrylate, methacrylates of ether alcohols, for example tetrahydrofurfuryl methacrylate, vinyloxyethoxyethyl methacrylate, methoxyethoxyethyl methacrylate, 1-butoxypropyl methacrylate, 1-methyl-(2-vinyloxy)ethyl methacrylate, cyclohexyloxymethyl methacrylate, methoxymethoxyethyl methacrylate, benzyloxymethyl methacrylate, furfuryl methacrylate, 2-butoxyethyl methacrylate, 2-ethoxyethoxymethyl methacrylate, 2-ethoxyethyl methacrylate, allyloxymethyl methacrylate, 1-ethoxybutyl methacrylate, methoxymethyl methacrylate, ethoxyethyl methacrylate, ethoxymethyl methacrylate and/or ethoxylated or propoxylated (meth)acrylates having preferably 1 to 20, especially 2 to 8 ethoxy groups or propoxy groups.

Particularly preferred examples of acrylate and/or methacrylate monomers usable in the context of the invention in particular are, but are not limited to, methyl (meth)acrylate, ethyl (meth)acrylate, propyl (meth)acrylate, isopropyl (meth)acrylate, butyl (meth)acrylate, isobutyl (meth)acrylate, hexyl (meth)acrylate, ethylhexyl (meth)acrylate, isodecyl (meth)acrylate, cyclohexyl (meth)acrylate, isobornyl (meth)acrylate, benzyl (meth)acrylate, phenyl (meth)acrylate, phenylethyl (meth)acrylate, 3,3,5-trimethylcyclohexyl (meth)acrylate, 2-butoxyethyl methacrylate, 2-ethoxyethoxymethyl methacrylate, 2-ethoxyethyl methacrylate, methacrylates of ether alcohols, for example methoxyethoxyethyl methacrylate, 1-butoxypropyl methacrylate, methoxymethoxyethyl methacrylate, 2-butoxyethyl methacrylate, 2-ethoxyethoxymethyl methacrylate, 2-ethoxyethyl methacrylate, 1-ethoxybutyl methacrylate, methoxymethyl methacrylate, 1-ethoxyethyl methacrylate, ethoxymethyl methacrylate and/or ethoxylated or propoxylated (meth)acrylates having preferably 1 to 20, especially 2 to 8, ethoxy groups or propoxy groups.

The notation “(meth)acrylate” here means both methacrylate, for example methyl methacrylate, ethyl methacrylate, etc., and acrylate, for example methyl acrylate, ethyl acrylate, etc., and mixtures of the two.

Possible initiators used for the free-radical polymerization of acrylates and/or methacrylates may for example be compounds that break down to free radicals under the polymerization conditions, for example peroxides, hydroperoxides, hydrogen peroxide, persulfates, azo compounds and/or what are called redox initiators. In some cases, it may also be advantageous to use mixtures of different initiators, for example mixtures of hydrogen peroxide and sodium or potassium peroxodisulfate. Examples of initiators that may preferably be used include organic peroxides, such as for example acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl peroxy-2-ethylhexanoate, tert-butyl perisononanoate, tert-butyl permaleate, tert-butyl perbenzoate, di-(2-ethylhexyl) peroxydicarbonate, dicyclohexyl peroxydicarbonate, di-(4-tert-butylcyclohexyl) peroxydicarbonate, dimyristyl peroxydicarbonate, diacetyl peroxydicarbonate, allyl peresters, cumyl peroxyneodecanoate, tert-butyl per-3,5,5-trimethylhexanoate, acetyl cyclohexylsulfonyl peroxide, dilauryl peroxide and/or tert-amyl peroxy-2-ethylhexanoate. Examples of further possible initiators are azo compounds, for example 2,2′-azobisisobutyronitrile, 2,2′-azobis(2,4-dimethylvaleronitrile) and 2,2′-azobis(4-methoxy-2,4-dimethylvaleronitrile).

If acrylate and/or methacrylate copolymers according to the invention are prepared with tert-butyl peroxy-2-ethylhexanoate (TBPEH) or tert-amyl peroxy-2-ethylhexanoate (APO) or a combination of TBPEH and APO as initiator, even better outcomes can then be achieved with respect to the results sought according to the invention.

It is therefore preferable that the at least one acrylate and/or methacrylate copolymer has been prepared using TBPEH (tert-butyl peroxy-2-ethylhexanoate) and/or APO (tert-amyl peroxy-2-ethylhexanoate) as initiator.

It is further preferable when the residual monomer content is <1% by weight based on the total at least one acrylate and/or methacrylate copolymer present in the composition according to the invention. The residual monomer content can be determined by customary methods; in particular, it can be determined via the solids content or by GC or HPLC. Corresponding compositions enable foams which are particularly advantageous according to the invention and are moreover also particularly low in emissions.

The composition according to the invention contains at least one catalyst. Suitable catalysts which are usable for the production of polyurethane foam are known to those skilled in the art from the prior art. Suitable catalysts can catalyse the isocyanate-polyol and/or isocyanate-water reactions and/or isocyanate trimerization.

It is preferable that the composition according to the invention contains at least one tin-containing catalyst, preferably in a total amount of less than 0.5 parts by weight, preferably less than 0.1 parts by weight, particularly preferably less than 0.01 parts by weight, especially preferably of from 0.0001 parts by weight to less than 0.01 parts by weight, based on 100 parts by weight of the total polyol component. In an alternative, particularly preferred embodiment of the invention, the composition according to the invention does not contain any tin-containing catalysts.

A preferred PU foam formulation, especially rigid PU foam formulation, in the context of the present invention has the composition given in Table 1.

TABLE 1
Composition of a preferred PU foam formulation

| Component | Parts by weight |
|---|---|
| Polyol containing at least one recycled polyol | 80 to 120 |
| Amine catalyst | >0 to 10 |
| Metal catalyst | 0 to 10 |
| Foam stabilizer of Formula 1 | 0.1 to 20 |
| Blowing agent | >0 to 40 |
| Further additives (flame retardants, etc.) | 0 to 300 |
| Isocyanate index: | 10 to 1000 |

The present invention further provides a process for producing PU foam, preferably rigid polyurethane foam, by reaction of a polyisocyanate component with a polyol component comprising at least one recycled polyol, in the presence of at least one catalyst and at least one blowing agent, wherein additionally at least one acrylate and/or methacrylate copolymer is used as foam stabilizer, wherein the at least one acrylate and/or methacrylate copolymer is used in a total amount of 0.1 to 20 parts by weight, preferably 0.5 to 10 parts by weight, particularly preferably 0.5 to 8 parts by weight, based on 100 parts by weight of the total polyol component. It is particularly preferable here that the process is effected using a composition according to the description herein.

The process according to the invention for producing PU foam, preferably rigid polyurethane foam, can preferably be conducted by any known methods, for example by manual mixing or preferably by means of foaming machines. If the process is conducted for example using foaming machines, it is possible to use high-pressure or low-pressure machines. For example, the process according to the invention can be carried out either batchwise or continuously and it is possible for example to use 1K, 1.5K or 2K systems as described for example in EP 3717538 A1, US 2007/0197672 A1, EP 1400547 A1 or WO 2013/072380 A2.

For further preferred embodiments of the process according to the invention, reference is also made to the statements already given above in connection with the composition according to the invention.

The present invention further provides a PU foam, in particular a rigid PU foam, produced by the abovementioned process according to the invention, particularly preferably using a composition according to the invention.

It is preferable when the PU foam, in particular rigid PU foam, according to the invention has a foam density of 5 to 900 kg/m³, particularly preferably 5 to 350 kg/m³, very particularly preferably 8 to 200 kg/m³.

The present invention further relates to the use of PU foam according to the invention, in particular rigid PU foam, as an insulating material and/or as a construction material, preferably in construction applications, in particular in spray foam and/or 1 & 1.5 component can foam, or in the refrigeration sector, as sound absorption material, as packaging foam, as imitation wood, as modelling foam, as headliner for automobiles, as automotive interior trim, as sealing foam or pipe lagging for pipes.

A particularly preferred composition according to the invention contains the following constituents:
polyol component comprising at least one recycled polyol,
polyisocyanate component,
at least one catalyst that catalyses the isocyanate-polyol and/or isocyanate-water reactions and/or isocyanate trimerization,
at least one acrylate and/or methacrylate copolymer as foam stabilizer,
at least one blowing agent,
optionally further additives, preferably fillers, liquid flame retardants, etc.

The polyol component consists of at least one polyol and optionally at least one organic compound containing at least two isocyanate-reactive groups, preferably selected from the group consisting of OH, NH and NH₂ groups. Polyols are organic compounds containing at least two hydroxyl groups (—OH).

If one of the above-mentioned organic compounds of the polyol component contains at least two OH groups, then this is exclusively assigned to the polyols for the purposes of the invention. This means that if an organic compound of the polyol component can be assessed as being both a polyol and an organic compound containing at least two isocyanate-reactive groups, preferably selected from the group consisting of OH, NH and NH₂ groups, then it is assigned exclusively to the polyols for the purposes of the invention. Based on its total weight, the polyol component preferably contains at least 50% by weight of those polyols containing only hydroxyl groups (—OH) as isocyanate-reactive groups.

Based on the total number of isocyanate-reactive groups in the polyol component, it is preferable that at least 50% of these be hydroxyl groups (—OH).

Appropriate compounds which may typically be used when producing PU are known to those skilled in the art and for example described in “Kunststoffhandbuch, Band 7, Polyurethane [Plastics Handbook, volume 7, Polyurethanes]”, Carl Hanser Verlag, 3rd Edition 1993, Chapter 3.1. It is customary to use compounds having OH numbers within the range from 10 to 1200 mg KOH/g. Particularly preferred compounds are all polyether polyols and/or polyester polyols typically used for production of polyurethane systems, especially polyurethane foams. Polyether polyols can preferably be obtained by reacting polyfunctional alcohols or amines with alkylene oxides. Polyester polyols are preferably based on esters of polybasic carboxylic acids (which may be either aliphatic, as in the case of adipic acid for example, or aromatic, as in the case of phthalic acid or terephthalic acid, for example) with polyhydric alcohols (preferably glycols).

In addition, it is possible for example to use polyether polycarbonate polyols, polyols based on natural oils (natural oil based polyols, NOPs; as for example described in WO 2005/033167 A2, US 2006/0293400 A1, WO 2006/094227 A2, WO 2004/096882 A1, US 2002/0103091 A1, WO 2006/116456 A1 or EP 1678232 A2), filled polyols, prepolymer-based polyols and/or recycled polyols.

According to the invention, the polyol component contains at least one recycled polyol, as described above.

The polyisocyanate component consists of at least one polyisocyanate having two or more isocyanate groups. Suitable polyisocyanates for the purposes of the present invention are all organic isocyanates having two or more isocyanate groups, in particular the aliphatic, cycloaliphatic, arylaliphatic and preferably aromatic polyfunctional isocyanates known per se. Examples that may be mentioned here are alkylene diisocyanates having 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, pentamethylene diisocyanate (PDI) and preferably hexamethylene 1,6-diisocyanate (HMDI), cycloaliphatic diisocyanates such as cyclohexane 1,3- and 1,4-diisocyanate and the corresponding isomer mixtures, methylene dicyclohexyl 4,4′-diisocyanate (H12MDI), isophorone diisocyanate (IPDI), methylcyclohexyl 2,4- and 2,6-diisocyanate and the corresponding isomer mixtures, and preferably aromatic diisocyanates and polyisocyanates such as toluene 2,4- and 2,6-diisocyanate (TDI) and the corresponding isomer mixtures, naphthalene diisocyanate, diethyltoluene diisocyanate, diphenylmethane 4,4′- or 2,2′- or 2,4′-diisocyanate (MDI) and polymethylene polyphenyl polyisocyanate (PMDI, “polymeric MDI”). The organic polyisocyanates may be used individually or in the form of mixtures thereof. It is likewise possible to use corresponding “oligomers” of the diisocyanates, such as the IPDI trimer based on the isocyanurate, biurets or uretdiones. Furthermore, the use of prepolymers based on the abovementioned isocyanates is possible. The mixture of MDI and more highly condensed analogues having an average functionality of 2 to 4 which is known as polymeric MDI (also referred to as “crude MDI”) is particularly suitable, as well as the various isomers of TDI in pure form or as isomeric mixture. It is also possible to use isocyanates which have been modified by the incorporation of urethane, uretdione, isocyanurate, allophanate and other groups, known as modified isocyanates. Examples of particularly suitable isocyanates are also detailed for example in EP 712578 A1, WO 00/47647 A1, WO 00/58383 A1, US 2007/0072951 A1, WO 2005/033167 A2 and WO 2005/085310, which are hereby fully incorporated by reference.

A preferred ratio of polyisocyanate component and polyol component, expressed as the index of the formulation (isocyanate index), i.e. as stoichiometric ratio of isocyanate groups to isocyanate-reactive groups (e.g. OH groups, NH groups) multiplied by 100, is in the range from 10 to 1000 and preferably 40 to 400. An index of 100 represents a molar ratio of reactive groups of 1:1.

Suitable catalysts which are usable for the production of polyurethanes, in particular PU foams, are known to those skilled in the art from the prior art. These can catalyse the isocyanate-polyol and/or isocyanate-water reactions and/or isocyanate trimerization. Usable compounds in the context of the present invention are preferably all compounds capable of catalysing the reaction of isocyanate groups with OH groups, NH groups or other isocyanate-reactive groups, and/or the reaction of isocyanate groups with one another. It is possible here to use the customary catalysts known from the prior art, such as for example amines (cyclic, acyclic; monoamines, diamines, oligomers having one or more amino groups), ammonium compounds, organometallic compounds and/or metal salts, preferably those of iron, bismuth, potassium and/or zinc. In particular, catalysts used may be mixtures of two or more compounds of this kind. Suitable use amounts depend on the type of catalyst and can preferably be in the range from 0.05 to 5 pphp (=parts by weight based on 100 parts by weight of polyol) for example in the case of amine catalysts, or preferably be in the range from 0.1 to 10 pphp for example in the case of potassium salts.

It has been found that compositions according to the invention containing little or no tin-based catalysts have proved to be particularly advantageous for achieving the results sought according to the invention. It is therefore preferable when tin-based catalysts are present in a total amount of less than 0.5 parts by weight, preferably less than 0.1 parts by weight, particularly preferably less than 0.01 parts by weight, especially preferably of from 0.0001 parts by weight to less than 0.01 parts by weight, based on 100 parts by weight of the total polyol component. According to an alternative, particularly preferred embodiment of the invention, the composition according to the invention does not contain any tin-based catalyst.

Foam stabilizers and the use thereof in the production of PU foams are known to those skilled in the art as described above. The composition according to the invention contains at least one acrylate and/or methacrylate copolymer as foam stabilizer. In addition to the foam stabilizers according to the invention, it is preferably additionally possible to use polyethersiloxane foam stabilizers, as described for example in CN 103665385 A, CN 103657518 A, CN 103055759 A, CN 103044687 A, US 2008/0125503 A1, US 2015/0057384 A1, EP 1520870 A1, EP 1211279 A1, EP 0867464 A1, EP 0867465 A1 or EP 0275563 A1, and also further Si-free surfactants. Byway of example, EP 2295485 A1 describes the use of lecithin and for example U.S. Pat. No. 3,746,663 the use of vinylpyrrolidone-based structures. Further Si-free foam stabilizers are described for example in EP 2511328 A2, DE 020011007479 A1, DE 3724716 C1, WO 95/16721 A1, EP 1985642 A1, U.S. Pat. No. 5,236,961 and German laid-open specification DE 2244350.

Blowing agents and the use thereof in the production of PU foams are known to those skilled in the art. The preferred use of a blowing agent or of a combination of two or more blowing agents depends in principle on the nature of the foaming process, on the nature of the system and on the use for the PU foam obtained. Both chemical and/or physical blowing agents may be used, as well as a combination of the two. Depending on the amount of blowing agent used, a foam having high or low density can be produced. For instance, foams can be produced having densities of 5 kg/m³ to 900 kg/m³, preferably 5 to 350 kg/m³, particularly preferably 8 to 200 kg/m³, especially 8 to 150 kg/m³.

Physical blowing agents that may for example be used are one or more of the appropriate compounds having suitable boiling points, for example hydrocarbons having 3, 4 or 5 carbon atoms, preferably cyclo-, iso-, or n-pentane, hydrofluorocarbons (HFCs), such as for example HFC 245fa, HFC 134a or HFC 365mfc, hydrochlorofluorocarbons (HCFCs), such as for example HCFC 141b, hydrofluoroolefins (HFOs) or hydrohaloolefins, preferably 1234ze, 1234yf, 1224yd, 1233zd(E) or 1336mzz, esters, preferably methyl formate, ketones, preferably acetone, ethers, preferably dimethoxymethane, or chlorinated hydrocarbons, such as for example dichloromethane or 1,2-dichloroethane, and also mixtures thereof.

Chemical blowing agents used may for example be one or more compounds that either react with NCO groups with the release of gases, for example water or formic acid, or release gases during the reaction as a result of the rise in temperature, for example sodium hydrogencarbonate.

As optional additives, it is possible for example to use one or more of the substances which are known from the prior art and are used in the production of polyurethanes, especially PU foams, for example crosslinkers, chain extenders, stabilizers against oxidative degradation (known as antioxidants), flame retardants, biocides, cell-refining additives, nucleating agents, cell openers, solid fillers, antistatic additives, thickeners, dyes, pigments, colour pastes, fragrances, and/or emulsifiers etc.

As optional flame retardant, the composition according to the invention can for example contain one or more of the known flame retardants suitable for the production of PU foams, such as for example halogen-containing or halogen-free organic phosphorus-containing compounds, such as for example triethyl phosphate (TEP), tris(1-chloro-2-propyl) phosphate (TCPP), tris(2-chloroethyl) phosphate (TCEP), dimethyl methanephosphonate (DMMP), dimethyl propanephosphonate (DMPP), ammonium polyphosphate or red phosphorus, nitrogen-containing compounds such as for example melamine, melamine cyanurate or melamine polyphosphate or halogenated compounds such as for example chlorinated and/or brominated polyether polyols and/or polyester polyols. It is also possible to use mixtures of different flame retardants.

Unless the opposite is apparent from this description, it is possible to combine any preferred or particularly preferred embodiment of the invention with one or more of the other preferred or particularly preferred embodiments of the invention.

Where ranges, general formulae or classes of compounds are stated, these are intended to encompass not just the corresponding ranges or groups of compounds explicitly mentioned but also all subranges and subgroups of compounds that can be obtained by extracting individual values (ranges) or compounds. Where documents are cited in the context of the present description, the entire content thereof, particularly with regard to the subject matter that forms the context in which the document has been cited, is intended to form part of the disclosure content of the present invention. Unless otherwise stated, reported percentages are percentages by weight. Where averages are reported, these are numerical averages unless otherwise stated. Where parameters that have been determined by measurement are stated, the measurements have been carried out at a temperature of 23° C. and preferably at a pressure of 101 325 Pa (standard pressure), unless stated otherwise.

The examples which follow serve merely to further elucidate the present invention and do not constitute any restriction of the present invention at all.

### EXAMPLES

### Synthesis of the Foam Stabilizers: Compounds A to G

### Compound A:

An initial charge of 30.01 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.2 g of TBPEH (tert-butyl peroxy-2-ethylhexanoate), 56.18 g of isobutyl methacrylate (i-BMA), 67.29 g of MPEG500 methacrylate (MPEG500MA, ethoxylated methacrylate) and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1 (eluent: THF; standard: polystyrene): Mw=7714 g/mol; Mn=2862 g/mol; PDI=2.7.

### Compound B:

An initial charge of 30.01 g of n-butyl acetate in a 500 ml four-neck flask equipped with reflux condenser and N₂ line, dropping funnel, precision glass stirrer (200 rpm) and Pt100 digital internal thermometer was heated to 145° C. using an oil bath. A mixture of 9.8 g of APO (tert-amyl peroxy-2-ethylhexanoate), 55.99 g of i-BMA, 67.06 g of MPEG500MA and 2.21 g of 2-mercaptoethanol was metered in over a period of 4 h using a peristaltic pump. The mixture was stirred at this temperature for a further 30 min. The mixture was cooled to 80° C., 0.14 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1 (eluent: THF; standard: polystyrene): Mw=5528 g/mol; Mn=2370 g/mol; PDI=2.3.

### Compound C:

An initial charge of 30.01 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.2 g of TBPEH, 54.69 g of isodecyl methacrylate (IDMA), 68.77 g of MPEG500MA and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1 (eluent: THF; standard: polystyrene): Mw=8452 g/mol; Mn=2783 g/mol; PDI=3.0.

### Compound D:

An initial charge of 30.00 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 4.54 g of TBPEH, 55.35 g of isodecyl methacrylate (IDMA), 72.77 g of MPEG500MA and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1 (eluent: THF; standard: polystyrene): Mw=11340 g/mol; Mn=2684 g/mol; PDI=5.1.

### Compound E:

An initial charge of 30.00 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.2 g of TBPEH, 88.40 g of isobutyl methacrylate (i-BMA), 35.06 g of MPEG500MA and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1 (eluent: THF; standard: polystyrene): Mw=6486 g/mol; Mn=2666 g/mol; PDI=2.4.

### Compound F:

An initial charge of 90.01 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.2 g of TBPEH, 53.33 g of isodecyl methacrylate (IDMA), 70.13 g of MPEG500MA and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 35 g of n-butyl acetate was added and the mixture was stirred for a further 30 min without heating.

GPC to DIN 55672-1 (eluent: THF; standard: polystyrene): Mw=5616 g/mol; Mn=2017 g/mol; PDI=2.8.

### Compound G:

An initial charge of 29.97 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.2 g of TBPEH, 95.41 g of isobutyl methacrylate (i-BMA), 28.50 g of MPEG500MA, 9.02 g of methyl methacrylate (MMA) and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 8 g of n-butyl acetate was added and the mixture was stirred for a further 30 min without heating.

GPC to DIN 55672-1 (eluent: THF; standard: polystyrene): Mw=6648 g/mol; Mn=2830 g/mol; PDI=2.3.

### Recycled Polyols 1 and 2

Recycled polyol 1 was produced by glycolysis, according to a method from H&S Anlagentechnik from 2012: https://www.dbu.de/OPAC/ab/DBU-Abschlussbericht-AZ-29395.pdf. For this purpose, a reactor from Parr (Parr Instrumental Company) equipped with a glass inner container and a mechanical stirrer was filled with 294.0 g of compressed PU foam pieces (approx. 1 cm×1 cm). As described below, the polyurethane foam used for the glycolysis was produced in accordance with recipe I from Table 2 using TEGOSTAB® B 8462 from Evonik Operations GmbH as foam stabilizer. Then, 152.3 g of the polyol Daltolac® R 471, 75.1 g of phthalic acid and 11.6 g of aqueous hydrogen peroxide solution (30% by weight in water) were added to the foam pieces. The reaction mixture was heated to 250° C. and held within a temperature range from 237° C. to 256° C. for 5 h. At the end of the reaction time, the heating was switched off, and when a reaction temperature of 160° C. was reached a second portion of 144.6 g of Daltolac® R 471 was added under nitrogen countercurrent. The liquid reaction mixture was cooled to room temperature and after decanting off was used as recycled polyol 1. The recycling process was repeated in order to provide a sufficiently large amount of recycled polyol for the foaming experiments.

Recycled polyol 2 was produced in an analogous manner to recycled polyol 1. Instead of freshly produced foam, foam pieces from used PU insulating panels based on polyether polyols were used.

### Polyurethane Foam

The performance comparison was carried out using the formulations shown in Table 2. The comparative foaming operations were carried out by manual mixing. For this purpose, polyol, catalysts, water, foam stabilizer, blowing agent and any further additives were weighed into a beaker and mixed with a disc stirrer (diameter 6 cm) at 1000 rpm for 30 s. The beaker was reweighed to determine the amount of blowing agent that had evaporated during the mixing operation and this was replenished. The MDI was now added, the reaction mixture was stirred with the stirrer described at 3000 rpm for 5 s and immediately transferred into an aluminium mould thermostatted to 45° C. and having a size of 145 cm×14 cm×3.5 cm, the mould being inclined at an angle of 10° (along the 145 cm long side) and lined with polyethylene film. The foam formulation was in this case introduced at the lower side, so that the expanding foam fills the mould in the feed region and rises in the direction of the higher side. The amount of the foam formulation used was calculated such that it was approx. 10% above the amount necessary for minimum filling of the mould (approx. 300 g). After 10 min, the foams were demoulded. One day after foaming, the foams were analysed. Surface quality and internal defects were assessed subjectively on a scale from 1 to 10, where 10 represents an (idealized) defect-free foam and 1 a very significantly defective foam. The thermal conductivity coefficient (A value in mW/m-K) was measured on 2.5 cm-thick discs with an instrument of the Hesto Lambda Control type, model HLC X206, at an average temperature of 10° C. in accordance with the specifications of standard EN12667:2001. The results were compared with TEGOSTAB® B 8499 from Evonik Operations GmbH as foam stabilizer not in accordance with the invention.

TABLE 2
PU formulations. Amounts reported in parts by weight

| | Recipe | Recipe | Recipe | Recipe | Recipe |
|---|---|---|---|---|---|
| Component | I | II | III | IV | V |
| Polyether polyol* | 100 | 65 | 50 | 65 | 50 |
| Recycled polyol 1 | | 35 | 50 | | |
| Recycled polyol 2 | | | | 35 | 50 |
| DABCO ® BL 11** | 0.8 | 0.8 | 0.8 | 0.8 | 0.8 |
| POLYCAT ® 9** | 3.5 | 3.5 | 3.5 | 3.5 | 3.5 |
| DABCO ® TMR 30** | 0.5 | 0.5 | 0.5 | 0.5 | 0.5 |
| Foam stabilizer | 3.0 | 3.0 | 3.0 | 3.0 | 3.0 |
| Water | 2.0 | 2.0 | 2.0 | 2.0 | 2.0 |
| Cyclopentane | 14 | 14 | 14 | 14 | 14 |
| MDI*** | 173 | 171 | 170 | 163 | 161 |

*Daltolac ® R 471 from Huntsman, OH number 470 mg KOH/g
**Amine catalysts from Evonik Operations GmbH
***Polymeric MDI, 200 mPa · s, 31.5% NCO, functionality 2.7.

The results are presented in Table 3.

TABLE 3
Foam properties

| | | | | Surface | Surface | |
|---|---|---|---|---|---|---|
| | Foam | Density | λ value | Upper | Lower | Internal |
| Recipe | stabilizer | (kg/m³) | (mW/m · K) | side | side | defects |
| I | B 8499 | 34.4 | 21.7 | 7.0 | 7.0 | 7.5 |
| I | A | 35.0 | 21.8 | 6.5 | 6.5 | 7.5 |
| I | B | 34.8 | 22.2 | 6.5 | 6.5 | 7.0 |
| I | C | 34.2 | 21.6 | 6.5 | 7.0 | 7.0 |
| I | D | 34.5 | 21.4 | 7.0 | 7.0 | 7.0 |
| I | E | 34.1 | 21.7 | 7.0 | 6.5 | 7.5 |
| I | F | 34.8 | 21.4 | 7.5 | 7.0 | 7.0 |
| I | G | 34.5 | 21.6 | 7.0 | 7.0 | 7.0 |
| II | B 8499 | 35.2 | 23.1 | 6.5 | 6.5 | 7.0 |
| II | A* | 36.0 | 22.6 | 6.0 | 6.0 | 6.5 |
| II | B* | 35.9 | 22.1 | 6.5 | 6.0 | 6.5 |
| II | C* | 35.1 | 22.4 | 6.5 | 6.5 | 7.0 |
| II | D* | 35.5 | 21.9 | 7.0 | 6.5 | 7.0 |
| II | E* | 35.0 | 21.8 | 7.0 | 7.0 | 7.0 |
| II | F* | 35.7 | 22.0 | 6.5 | 6.5 | 7.0 |
| II | G* | 36.0 | 22.4 | 7.0 | 6.5 | 7.0 |
| III | B 8499 | 35.8 | 23.6 | 5.5 | 5.0 | 6.0 |
| III | A* | 36.3 | 22.1 | 6.0 | 5.5 | 6.5 |
| III | B* | 36.2 | 22.4 | 6.0 | 5.5 | 6.5 |
| III | C* | 35.8 | 21.7 | 6.5 | 5.5 | 6.5 |
| III | D* | 35.4 | 22.8 | 6.5 | 6.0 | 7.0 |
| III | E* | 36.0 | 21.9 | 6.5 | 6.5 | 7.0 |
| III | F* | 36.2 | 21.9 | 6.5 | 6.5 | 7.0 |
| III | G* | 36.1 | 22.0 | 6.0 | 6.5 | 7.0 |
| IV | B 8499 | 34.9 | 24.4 | 6.0 | 6.5 | 6.5 |
| IV | A* | 35.5 | 23.0 | 6.0 | 6.5 | 6.5 |
| IV | B* | 35.4 | 23.9 | 6.0 | 6.5 | 6.5 |
| IV | C* | 34.6 | 23.7 | 6.5 | 7.0 | 6.0 |
| IV | D* | 34.2 | 23.1 | 6.5 | 7.0 | 7.0 |
| IV | E* | 35.8 | 23.4 | 6.5 | 7.0 | 7.0 |
| IV | F* | 35.3 | 22.9 | 7.0 | 7.5 | 7.5 |
| IV | G* | 3.54 | 23.3 | 7.0 | 7.5 | 7.0 |
| V | B 8499 | 36.3 | 23.9 | 5.5 | 5.5 | 5.5 |
| V | A* | 36.8 | 23.7 | 6.0 | 6.0 | 6.0 |
| V | B* | 37.2 | 23.5 | 6.0 | 6.0 | 6.5 |
| V | C* | 35.8 | 23.4 | 6.5 | 6.5 | 7.0 |
| V | D* | 35.4 | 23.4 | 6.5 | 6.5 | 6.5 |
| V | E* | 35.9 | 22.0 | 6.0 | 7.0 | 7.0 |
| V | F* | 36.2 | 21.9 | 7.0 | 7.0 | 7.5 |
| V | G* | 36.4 | 22.8 | 7.0 | 7.0 | 6.5 |

*composition according to the invention

The results show that the acrylate and/or methacrylate copolymers used as foam stabilizers not only exhibit comparable results to polyether-modified siloxanes in conventional polyurethane formulations but also, when using recycled polyols, lead to usable foam qualities and thermal conductivities that are on the same level as those of polyurethane formulations without recycled polyol. All other use-relevant foam properties are affected only negligibly, if at all, by the foam stabilizers according to the invention.

1. A composition for the production of polyurethane foam, the composition comprising: a polyol component comprising at least one recycled polyol,
a polyisocyanate component,
at least one catalyst that catalyses an isocyanate-polyol and/or isocyanate-water reaction and/or an isocyanate trimerization, and
at least one blowing agent,
wherein the composition additionally contains at least one acrylate and/or methacrylate copolymer as foam stabilizer, wherein the at least one acrylate and/or methacrylate copolymer is present in a total amount of 0.1 to 20 parts by weight, based on 100 parts by weight of a total polyol component.

2. The composition according to claim 1, wherein the at least one blowing agent is selected from the group consisting of
hydrocarbons having 3, 4 or 5 carbon atoms,
hydrofluoroolefins,
hydrohaloolefins,
and oxygen-containing blowing agents.

3. The composition according to claim 1, wherein the at least one acrylate and/or methacrylate copolymer contains at least one comonomer of the H₂C═CR¹—COOR² type and at least one comonomer of the H₂C═CR¹—COOR³ type, where
R¹=each independently H or methyl, where different comonomers having different R¹ substituents are optionally present within one molecule,
R²=each independently a radical selected from the group consisting of aliphatic and aromatic hydrocarbons having 1 to 25 carbon atoms, where different comonomers having different R² substituents are optionally present within one molecule,
R³=each independently a polyether radical according to Formula 1, where different comonomers having different R³ substituents are optionally present within one molecule, 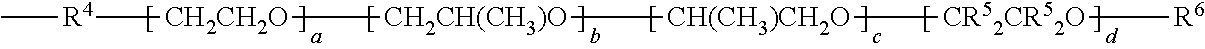
Formula (1)
where
R⁴=each independently —CH₂—O—, —CH₂—CH₂—O—, —CH₂—CH₂—CH₂—O—, —CH₂—CH₂—CH₂—CH₂—O— or —CH₂—CH₂—CH₂—CH₂—CH₂—O—, where R⁴ is optionally absent,
R⁵=each independently identical or different alkyl radicals which have 1 to 18 carbon atoms and optionally have ether functions, or identical or different aryl radicals which have 6 to 18 carbon atoms and optionally have ether functions, or H,
R⁶=each independently identical or different radicals selected from the group consisting of R⁷, —C(O)R⁷, —CH₂—CH(OH)—CH₂OH and —CH₂—C(CH₂OH)₂—CH₂—CH₃,
R⁷=each independently identical or different aliphatic hydrocarbons having 1 to 25 carbon atoms, identical or different aryl radicals having 6 to 16 carbon atoms or H,
a=0 to 300,
b=0 to 300,
c=0 to 300, and
d=0 to 300,
where a+b+c+d=2 to 500.

4. The composition according to claim 1, wherein the at least one acrylate and/or methacrylate copolymer has a weight-average molecular weight MW, determined by gel permeation chromatography in accordance with DIN 55672-1:2016-03 (eluent: tetrahydrofuran; standard: polystyrene), in a range from 500 to 100 000 g/mol.

5. The composition according to claim 1, wherein the at least one recycled polyol is employed in a total amount of at least 10 parts by weight, based on 100 parts by weight of the total polyol component.

6. The composition according to claim 1, wherein the at least one recycled polyol employed has been obtained by depolymerization of polyurethane, wherein the at least one recycled polyol optionally comprises or optionally further comprises various recycled polyols from differing depolymerization processes.

7. The composition according to claim 1, wherein the at least one recycled polyol employed is obtained by depolymerization of polyurethane foam.

8. The composition according to claim 1, wherein the at least one recycled polyol employed is obtained from a PU waste foam.

9. The composition according to claim 1, wherein the at least one acrylate and/or methacrylate copolymer has been prepared with tert-butyl peroxy-2-ethylhexanoate and/or tert-amyl peroxy-2-ethylhexanoate as initiator.

10. The composition according to claim 1, wherein a residual monomer content is <1% by weight based on a total of the at least one acrylate and/or methacrylate copolymer present.

11. The composition according to claim 1, wherein at least one tin-containing catalyst is present.

12. The composition according to claim 1, wherein no tin-containing catalyst is present.

13. A process for producing PU foam by reaction of a polyol component with a polyisocyanate component, wherein the reaction is effected employing the composition according to claim 1.

14. A PU foam produced by the process according to claim 13.

15. A method, comprising:
employing the PU foam according to claim 14 as an insulating material and/or as a construction material, or in the refrigeration sector, as sound absorption material, as packaging foam, as imitation wood, as modelling foam, as headliner for automobiles, as automotive interior trim, as sealing foam or pipe lagging for pipes.

16. The composition according to claim 1, wherein the at least one acrylate and/or methacrylate copolymer is present in a total amount of 0.5 to 8 parts by weight, based on 100 parts by weight of the total polyol component.

17. The composition according to claim 2, wherein the at least one blowing agent is selected from the group consisting of cyclopentane, isopentane, n-pentane, 1234ze, 1234yf, 1224yd, 1233zd(E), 1336mzz, methyl formate, acetone, and dimethoxymethane.

18. The composition according to claim 3,
wherein each R² is independently methyl, ethyl, n-butyl, isobutyl, t-butyl, 2-ethylhexyl, isodecyl, cyclohexyl, benzyl, phenyl, isobornyl or allyl;
wherein each R⁵ is independently H, methyl, ethyl or benzyl;
wherein a is from 0 to 80;
wherein b is from 0 to 80;
wherein c is from 0 to 80;
wherein d is 0;
wherein a+b+c+d is from 8 to 100.

19. The composition according to claim 4, wherein the at least one acrylate and/or methacrylate copolymer has a weight-average molecular weight MW, determined by gel permeation chromatography in accordance with DIN 55672-1:2016-03 (eluent: tetrahydrofuran; standard: polystyrene), in the range from 1000 to 15000 g/mol.

20. The composition according to claim 5, wherein the at least one recycled polyol is employed in a total amount of more than 30 parts by weight, based on 100 parts by weight of the total polyol component.
